(19) United States
(12) Patent Application Publication
(10) Pub. No.: US 2005/0207747 A1
(43) Pub. Date: Sep. 22, 2005

(54) Imaging apparatus

(76) Inventor: Toshihiko Hirota, Osaka (JP)

Correspondence Address: BRINKS HOFER GILSON & LIONE, P.O. BOX 10395, CHICAGO, IL, 60610, US

(21) Appl. No.: 10/889,473

(22) Filed: Jul. 12, 2004

(30) Foreign Application Priority Data
Mar. 18, 2004 (JP) 2004-077610

(51) Int. Cl. G03B 29/00

(52) U.S. Cl. 396/335

(57) ABSTRACT

An imaging apparatus according to the present invention comprises an imaging unit 11 on which a subject image entered in an imaging optical path is focused; a grip portion 4 to be held when imaging operation; a driven unit 10 which is disposed substantially in the vicinity of the imaging unit 11 and conducts a part of imaging operation of the imaging apparatus; and a driving unit 12 which drives the driven unit 10, a part of the driving unit 12 being disposed on the opposite side to the grip portion 4 with respect to the imaging optical path.

This application is based on application No. 2004-77610 filed in Japan on Mar. 18, 2004, the contents of which are hereby incorporated by reference.

### BACKGROUND OF THE INVENTION

The present invention relates to an imaging apparatus using a silver salt film, an imaging device and so on.

Conventionally, in a lens interchangeable and single-lens reflex type of digital camera, as shown in FIGS. 16 and 17, a focal-plane shutter 110 and an imaging device 111 are disposed on an imaging optical path inside a body 101. On the left side of the imaging optical path toward the front of the body 101 (hereinafter, simply referred to as left side), a grip portion 104 to be gripped by a right hand is formed on the left end portion of the body 101; a battery storage portion 108 for storing a battery 107, circuit boards 109a, 109b, 109c and a shutter drive portion 112 are disposed inside the body 101. On the right side of the imaging optical path toward the front of the body 101 (hereinafter, simply referred to as right side), a mirror drive portion 113 and a part of a drive unit 114 are disposed inside the body 101. On the right end portion of the body 101 is formed a hold portion 105 to be held by a left hand. Thus, the right side of the body 101 has many wasted spaces, enlarging the total lateral width L3 made by adding the left side dimension L1 and the right side dimension L2 of the imaging optical path.

Furthermore, as shown in FIGS. 18 and 19, there has been a camera in which the right side dimension L2′ of the imaging optical path is minified by excluding the hold portion 105 of FIG. 17, reducing the total lateral width L3′ and making the camera compact. However, the camera has a disadvantage that it is very hard to hold the body 101 by the left hand, causing a blurring due to a camera shake; and that the most part of the weight of the camera is supported by the right hand, making one fatigued.

In Japanese Laid-open patent publication No. H7-131695, it is described that when a shutter having a large format for a silver salt camera is mounted on an electronic still camera having a small format, the shutter is shifted in a running direction of shutter blades with respect to a photoelectric conversion device to sufficiently derive a performance of the shutter. However, this arrangement causes the same disadvantages as above.

In Japanese Laid-open patent publication No. 2002-182268, it is described that a drive mechanism portion of s shutter is disposed on opposite side to a side where an imaging light flux is reflected by a mirror. This arrangement is possible to minify a lateral width of a body of a camera, though a height of the body becomes large. In addition, since the arrangement has such a construction that the shutter blades are driven in a lateral direction of a screen, i.e. in a direction along a large dimension of the screen, it is necessary to increase a speed of the shutter blades. As a result, an actuator generating a large drive force has to be used. Thus, the above arrangement has a disadvantage that cost and size rise up.

### SUMMARY OF THE INVENTION

In view of the above disadvantages of the prior art, an object of the present invention is to provide an imaging apparatus which is easy to hold a body and possible to attain downsizing and also low cost.

In a first aspect of the present invention, there is provided an imaging apparatus, comprising:
an imaging unit on which a subject image entered in an imaging optical path is focused;
a grip portion to be held when imaging operation;
a driven unit which is disposed substantially in the vicinity of the imaging unit and conducts a part of imaging operation of the imaging apparatus; and
a driving unit which drives the driven unit, a part of the driving unit being disposed on the opposite side to the grip portion with respect to the imaging optical path.

The imaging unit may be a silver salt film in the case of silver salt camera and an imaging device in the case of digital camera.

In the present invention, as the part of the driving unit is disposed on the opposite side to the grip portion, comparing to the conventional imaging apparatus in which the driving unit exists on the same side as the grip portion, the side of the grip portion becomes small by a space that the part of the driving unit goes out of existence. In addition, on the opposite side to the grip portion, as the part of the driving unit is disposed in a space that originally exists in order to ensure hold of the imaging apparatus, there is no dimensional change. Thus, it is possible to ensure the hold of the imaging apparatus and also ensure a larger space for mounting parts without changing the entire width of the imaging apparatus. It is also possible to make the cost low.

The imaging unit is preferably an imaging device of photo-electrical conversion family. The photo-electrical conversion family includes CCD and so on. In the imaging apparatus as represented by digital camera utilizing such imaging device, since there is no space for the spool and the patrone unlike in the case of the silver salt camera, it is possible to mount larger parts or units on the side of the grip portion where the driving unit goes out of existence.

Preferably, the driven unit is a shutter member, and wherein the part of imaging operation is to allow and disallow an imaging light flux to pass toward the imaging unit.

Preferably, the part of the driving unit is further disposed substantially in the vicinity of the imaging unit.

Preferably, the imaging apparatus, further comprising:
an electric circuit board for controlling the imaging unit; and
a battery storage portion for storing a battery for driving the imaging apparatus;
wherein at least one of the electric circuit board and the battery storage portion is disposed substantially in the vicinity of the imaging unit and on the side of the grip portion.

According to the above construction, on the side of the grip portion where the driving unit goes out of existence, it is possible to dispose the electric circuit board on which many electric devices are mounted and the battery storage portion in which the battery having a larger capacity and size is stored.

Preferably, the part of the driving unit is at least one of a first drive unit for moving the shutter member from a first position to a second position and a second drive unit for moving the shutter member from the second position to the first position. For example, the first drive unit is a spring for driving the shutter while the second drive unit is a motor, gears, levers and so on for charging the spring.

According to the above construction, it is possible to effectively dispose the unit having a larger dimension in the imaging optical path than the shutter member, enabling to provide an imaging apparatus of small size and low cost.

Preferably, the first drive unit utilizes a resilient force of a spring as a drive source. According to this construction, it is possible to constitute a simple and powerful drive unit of the shutter blade in low cost.

Preferably, the second drive unit is provided with an at least one actuator of electro-mechanical conversion family. The actuator of electro-mechanical conversion family means motor, solenoid, piezoelectric element and so on. According to this construction, it is possible to convert an electric energy to a work for driving the shutter blade by a simple construction, enabling to provide a compact and simple imaging apparatus.

In a second aspect of the present invention, there is provided an imaging apparatus, comprising:
an imaging unit on which a subject image entered in an imaging optical path is focused;
a grip portion to be held when imaging operation, the grip portion being disposed on one end of the imaging apparatus;
a driven unit which is disposed substantially in the vicinity of the imaging unit and conducts a part of imaging operation of the imaging apparatus; and
a driving unit which drives the driven unit; characterizing in that:
the grip portion, the imaging unit and the driving unit are disposed in this order from the one end of the imaging apparatus where the grip portion is disposed to the other opposite end.

In a third aspect of the present invention, there is provided an imaging apparatus, comprising:
an imaging unit on which a subject image entered in an imaging optical path is focused;
a shutter body which is disposed substantially in the vicinity of an imaging surface of the imaging unit, the shutter body comprising a shutter blade which is movable within a surface perpendicular to the imaging optical path between a first position where an imaging light flux is interrupted and a second position where the imaging light flux is allowed to pass;
a shutter drive unit for driving the shutter blade; and
a grip portion to be held when imaging operation;
wherein at least a part of the shutter drive unit is disposed substantially in the vicinity of the imaging surface and on the opposite side to the grip portion with respect to the imaging optical path.

According to the present invention, since at least one part of the drive unit is disposed on the opposite side to the grip portion, it is possible to minify the imaging apparatus by a space that the part of the driving unit goes out of existence; while on the opposite side to the grip portion, it is possible to dispose the part of drive unit within a space having a configuration to be held by a left hand. Therefore, such space can be utilized for a shutter and so on. As a result, the present invention has an advantage that it is easy to hold the body and possible to attain downsizing and also low cost.

### BRIEF DESCRIPTION OF THE DRAWINGS

Further objects and advantages of the present invention will become clear from the following description taken in conjunction with the preferred embodiments thereof with reference to the accompanying drawings, in which:

FIG. 1 is a front view of a camera of a first embodiment according to the present invention;

FIG. 2 is a cross sectional view of the camera of FIG. 1;

FIGS. 3A, 3B are vertical sectional views of the camera of FIG. 1, FIG. 3A showing a mirror charge completion state, and FIG. 3B showing a mirror run completion state;

FIGS. 4A, 4B are front views of a shutter body of the camera of FIG. 1, FIG. 4A showing a shutter charge completion state, FIG. 4B showing a shutter run completion state;

FIG. 5 is a cross sectional view of a camera of a second embodiment according to the present invention;

FIG. 6 is a cross sectional view of a camera of a third embodiment according to the present invention;

FIG. 7 is a front view of a drive unit;

FIG. 8A is a front view of a mirror charge portion of the drive unit and FIG. 8B is a side view of a mirror drive portion, each showing a mirror charge completion state;

FIG. 9A is a front view of the mirror charge portion of the drive unit and FIG. 9B is a side view of the mirror drive portion, each showing a mirror run completion state;

FIGS. 10A, 10B are front views of a shutter charge portion of the drive unit, FIG. 10A showing a shutter charge completion state, FIG. 10B showing a shutter run completion state;

FIG. 11A is a front view of a shutter drive portion and FIG. 11B is a side view thereof, each showing a shutter charge completion state;

FIG. 12A is a front view of a shutter drive portion and FIG. 12B is a side view thereof, each showing a shutter run completion state;

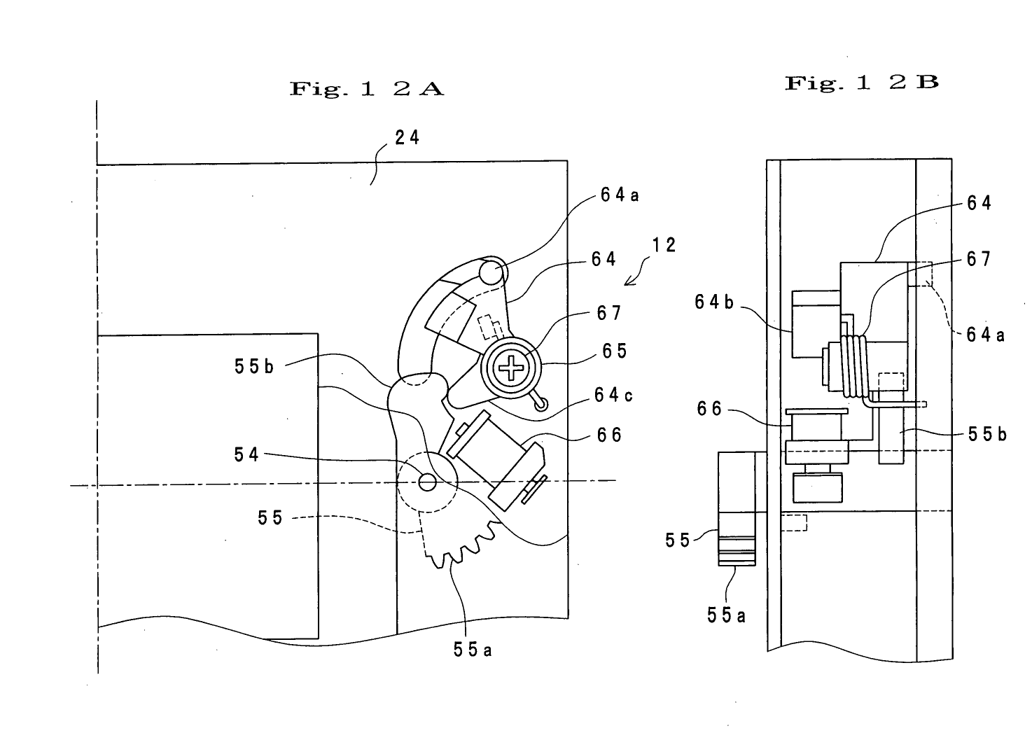

FIG. 13 is a front view of a camera showing a mounting and dismounting structure of a shutter unit and a drive unit;

FIG. 14A is a bottom view of a camera with a bottom cover removed showing a mounting and dismounting structure of a shutter unit and a drive unit, FIG. 14B is a bottom view of the shutter unit and the drive unit dismounted from the body;

FIGS. 15A, 15B are front views of an another embodiment of a shutter charge portion, FIG. 15A showing a shutter charge completion state, FIG. 15B showing a shutter run completion state;

FIG. 16 is a front view of a camera of a prior art;

FIG. 17 is a cross sectional view of the camera of FIG. 16;

FIG. 18 is a front view of an another camera of a prior art; and

FIG. 19 is a cross sectional view of the camera of FIG. 16.

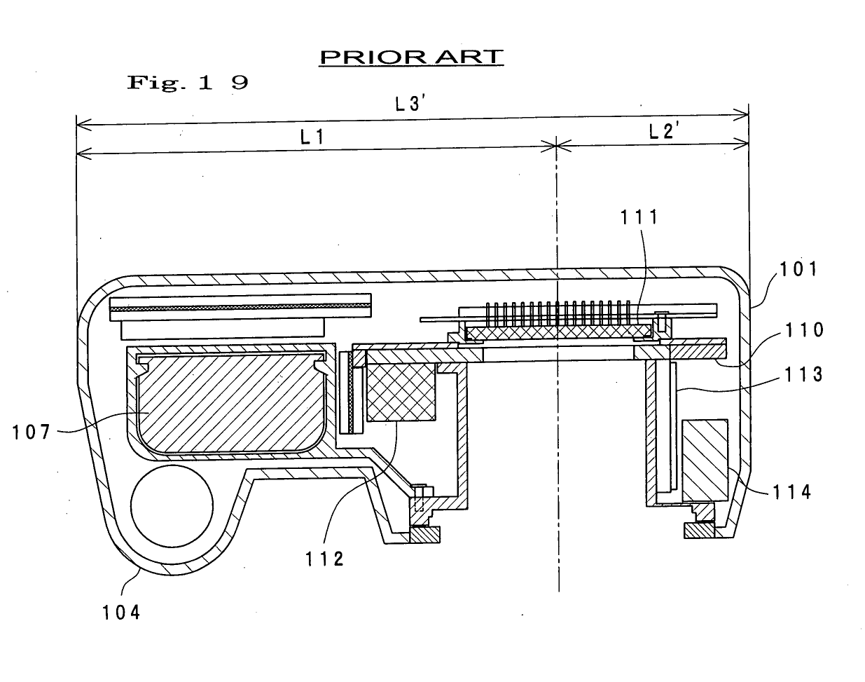

### DETAILED DESCRIPTION OF THE PREFERRED EMBODIMENTS

Some embodiments of the present invention will be explained with reference to the drawings hereinafter.

<General Arrangement Construction>

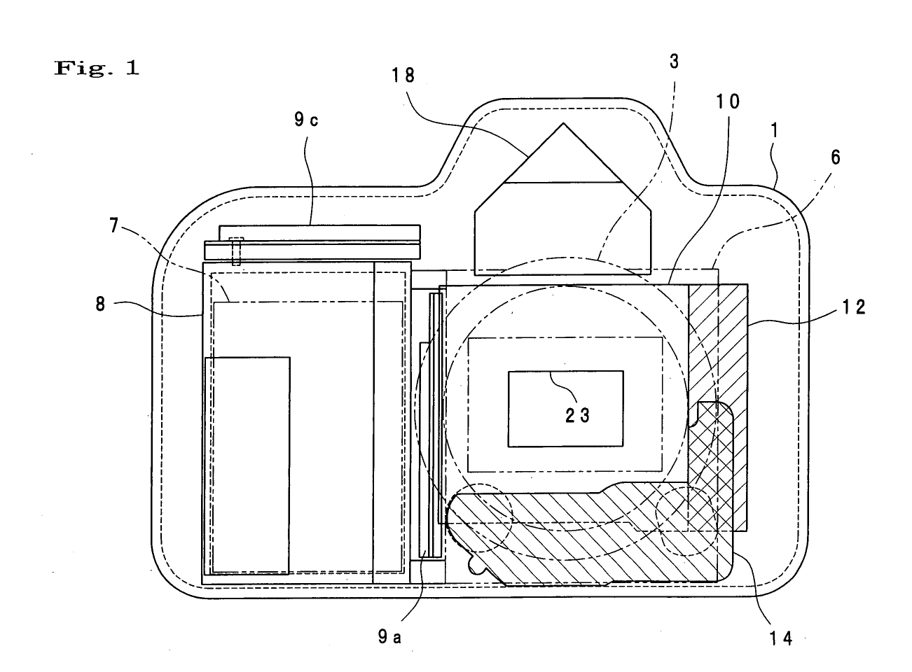

FIGS. 1-3 show a lens interchangeable and single-lens reflex type of digital camera as an imaging apparatus of a first embodiment according to the present invention with a focal-plane type of shutter. First of all, a general arrangement of units constituting the camera will be explained.

On the front surface of the body 1 of the camera is formed a circular opening 2, on an edge of which a mount 3 of annular shape for mounting an interchangeable lens not shown is fixed. The mount 3 constitutes a lens restraining means for restraining the interchangeable lens in a direction of optical axis. The central axis of the mount 3 is the optical axis, along which an imaging optical path is formed. On the front surface of the body 1 of the left side of the imaging optical path toward the front of the body 1 is formed a grip portion 4 comprising a convex portion 4a which is gripped by a right hand of a photographer and a concave portion 4b in which fingers enter. On the right side of the imaging optical path toward the front of the body 1 is formed a hold portion 5 which is held by a left hand of the photographer.

Inside the body 1, a frame body 6 of rectangular cross section with the front and rear ends opened is provided behind the mount 3. The frame body 6 encloses the imaging optical path to prevent an undesirable light from entering and also functions as a central construct of the body 1.

On the left side of the frame body 6, a battery storage room 8 for storing a battery 7 is disposed. Between the battery storage room 8 and the frame body 6, a first circuit board 9a is disposed. Behind and above the battery storage room 8, a second circuit board 9b and a third circuit board 9c are disposed.

In the rearward of the frame body is disposed a shutter body 10 behind which in turn is disposed an imaging device 11 of photo-electric conversion family. On the front surface of the extension of the shutter body 10 to the right side and on outer right side of the frame body 6 is disposed a shutter drive portion 12. That is to say, the shutter drive portion 12 is disposed in the vicinity of the imaging surface of the imaging device 11 and on the opposite side to the grip portion 4 toward the front surface of the body 1. Between the shutter drive portion 12 and the frame body 6 is disposed a mirror drive portion 13. A drive unit 14 which charges both the shutter drive portion 12 and the mirror drive portion 13 and drives a focus lens assembly movably provided in the interchangeable lens not shown in the optical axis when focusing, i.e. conducts focusing drive is provided in a layout of inverse L shape from the front side of the shutter drive portion 12 to the underside of the frame body 6.

In the frame body 6 is disposed a mirror 15. In the top wall of the frame body 6 is formed an opening 16, in which a focusing plate 17 is disposed. Above the focusing plate 17 is disposed a pentaprism 18. In the rearward of the pentaprism 18 are disposed an ocular lens system 19 and a ocular window 20. In the bottom wall of the frame body 6 is also formed an opening 21, on the underside of which is provided an AF module 22.

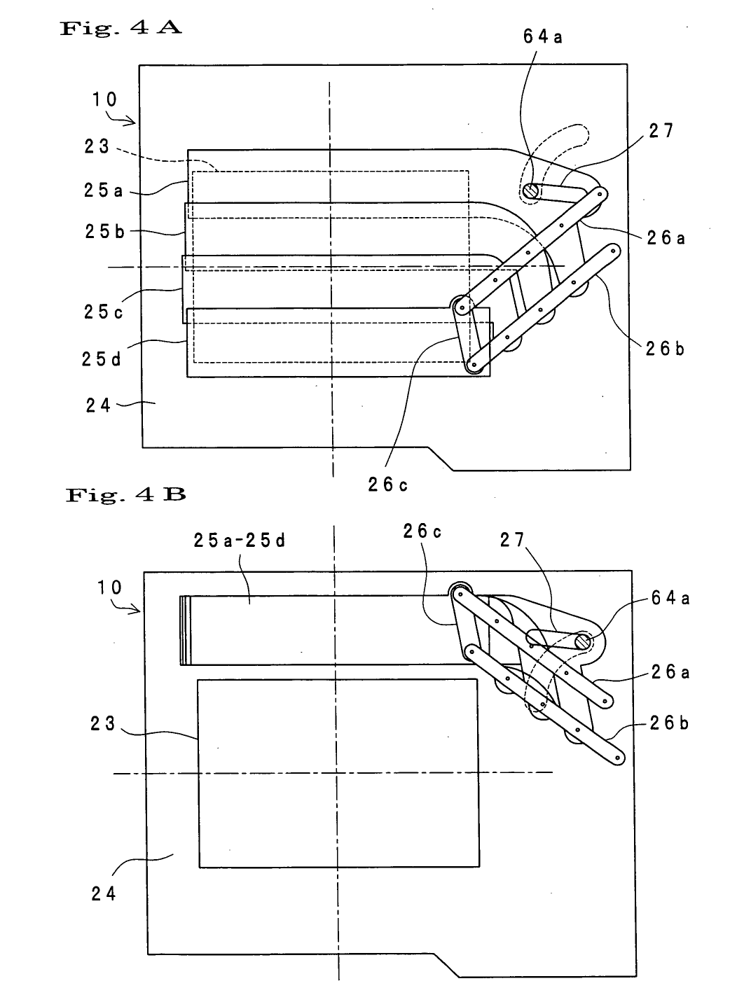

As shown in FIG. 4, the shutter body 10 comprises a shutter base 24 in which a rectangular exposure window 23 is formed and a plurality of shutter blades 25a, 25b, 25c, 25d for opening and closing the exposure window 23 of the shutter base 24. One end of each shutter blade 25a, 25b, 25c, 25d is attached on parallel link members 26a, 26b, 26c attached on the shutter base 24. On the first shutter blade 25a is formed a cam hole 27, in which a cam pin 64a of a shutter drive lever 64 of the shutter drive portion 12 which will be explained hereinafter is slidably inserted. According to the construction, the shutter blades 25a-25d are movable between a first position where the shutter blades 25a-25d close the exposure window 23 to intercept the imaging light flux (a charge complete state that a charge operation to the drive mechanism is completed) and a second position where the shutter blades 25a-25d open the exposure window 23 to allow the transmission of the imaging light flux (a run complete state that the drive mechanism completes a run operation).

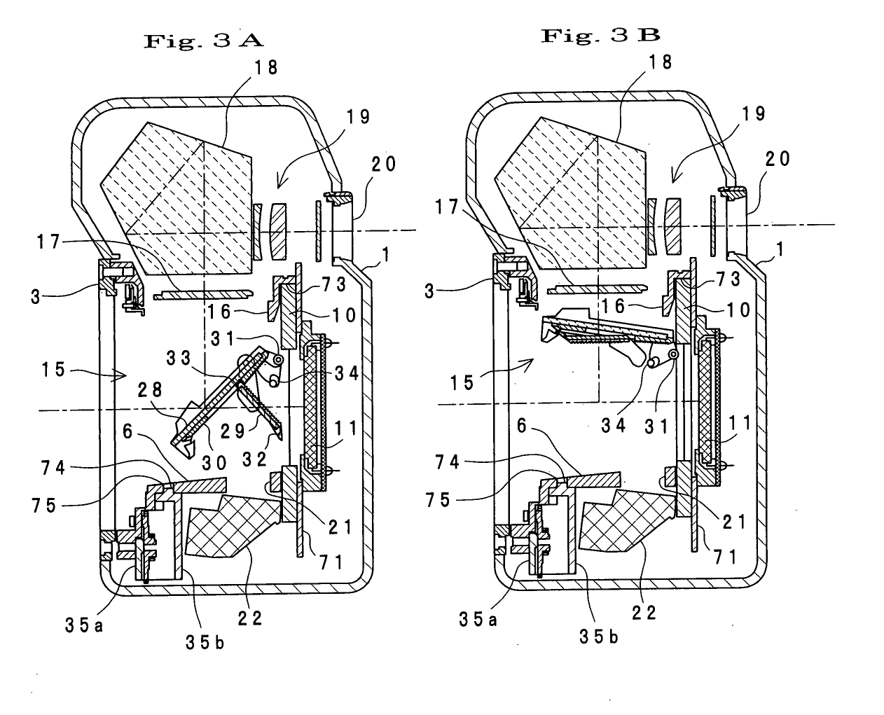

As shown in FIG. 3, the mirror 15 comprises a main mirror 28 and a sub-mirror 29. The main mirror 28 is supported on a main mirror holder 30 and attached on the frame body 6 rotatably around a rotation axis 31 of the main mirror holder 30. The sub-mirror 29 is supported on a sub-mirror holder 32 and attached on the main mirror holder 30 rotatably around a rotation axis 33 of the sub-mirror holder 32 so that the sub-mirror 29 can rotate relatively to the sub-mirror 29 by a rotation force of the main mirror holder 30 as a drive source. According to the construction, the mirror 15 are movable between a first position where, as shown in FIG. 3A, the main mirror 28 and the sub-mirror 29 are positioned within the imaging optical path and declined with respect to the imaging optical path to reflect the imaging light flux (a charge complete state that a charge operation to the drive mechanism is completed) and a second position where, as shown in FIG. 3B, the main mirror 28 and the sub-mirror 29 are retreated from the imaging optical path to direct the imaging light flux to the imaging device 11 (a run complete state that the drive mechanism completes a run operation). In the vicinity of the rotation axis 31 of the main mirror holder 30, a drive shaft 34 is provided.

In the charge complete state at the time of not photographing, an image which is focused on the focusing plate 17 after passing through the interchangeable lens not shown and reflecting on the main mirror 28 can be seen from the ocular window 20 via the pentaprism 18 and the ocular lens system 19. On the other hand, as the vicinity of the center of the optical axis of the main mirror 28 comprises a half mirror, a part of light quantity passing through the main mirror 28 is reflected downward by the sub-mirror 29 and directed to the AF module 22 so that a defocus quantity can be detected to adjust the lens focus by means of the drive unit 14. In the run complete state, the mirror 15 is retreated from the imaging optical path and the exposure window 23 of the shutter body 10 is opened so that the imaging light flux can be directed to and focused on the imaging device 11 to record it.

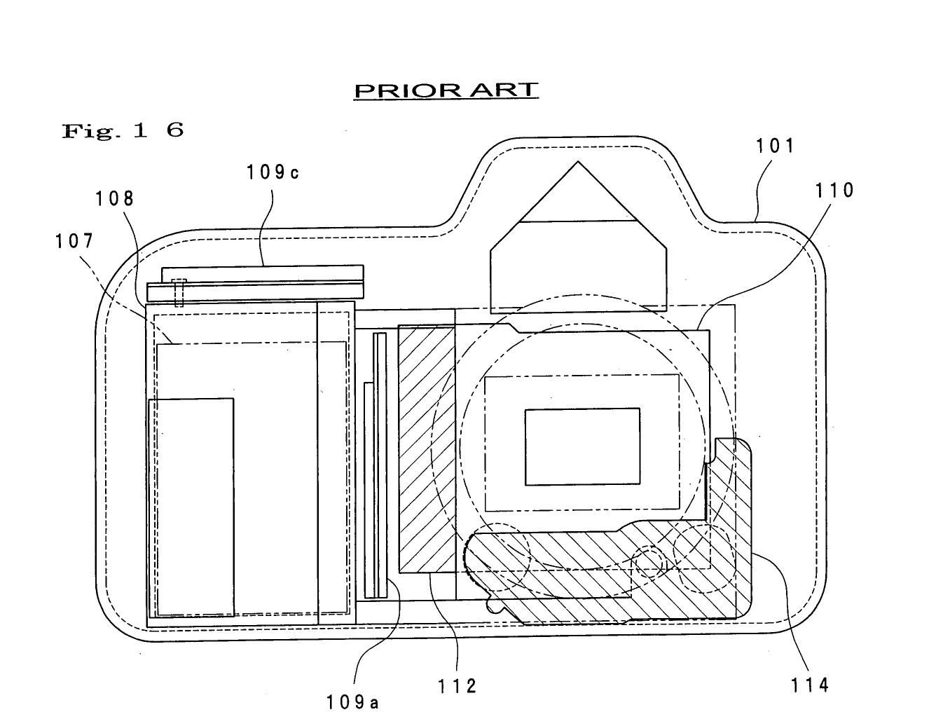

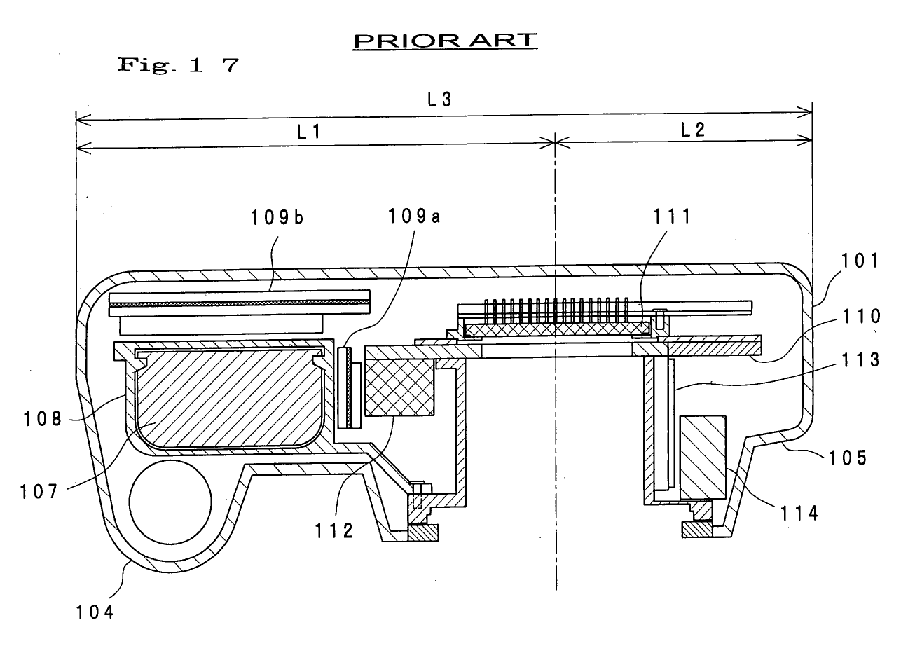

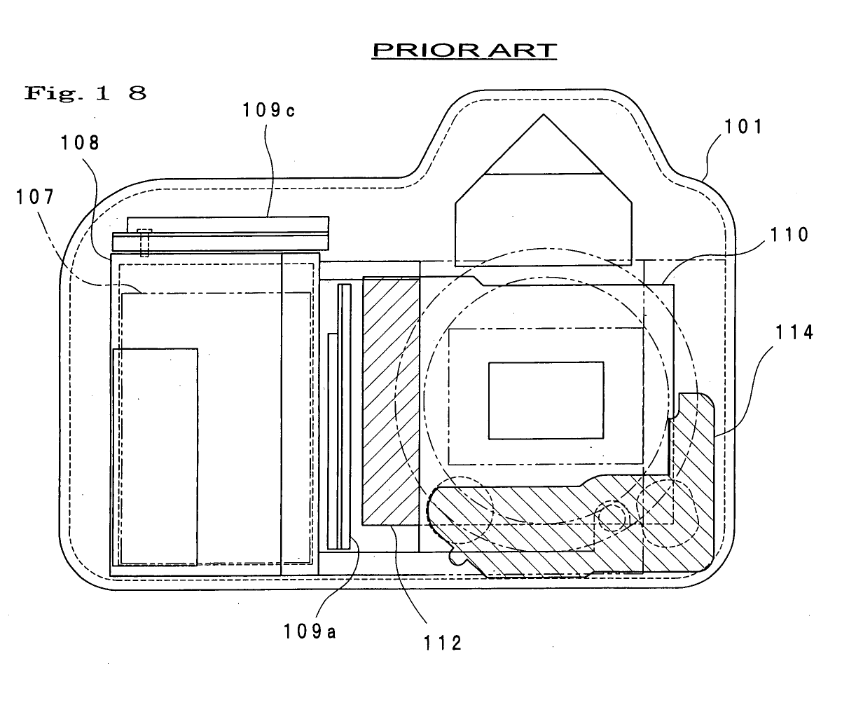

In the camera having above arrangement construction, the lateral width of the body 1 is decided substantially by the battery storage room 8, the first circuit board 9a, the shutter body 10, the shutter drive portion 12 and the mirror drive portion 13. However, since the shutter drive portion 12 is disposed on the right side of the imaging optical path, the lateral width L3′ of the camera is smaller than the lateral width L3 of the conventional camera as shown in FIGS. 16, 17 in which the shutter drive portion 12 has been disposed on the left side of the imaging optical path and more compact. In addition, in spite that the lateral width L3′ of the camera is coequal with the lateral width L3′ of the conventional camera as shown in FIGS. 17, 18, the hold portion 5 is formed on the right side. Moreover, it is possible to grip both the grip portion 4 on the left side of the body 1 and the hold portion 5 on the right side to securely hold the body 1 by both hands, causing few possibilities both of a blurring due to a camera shake and a fatigue.

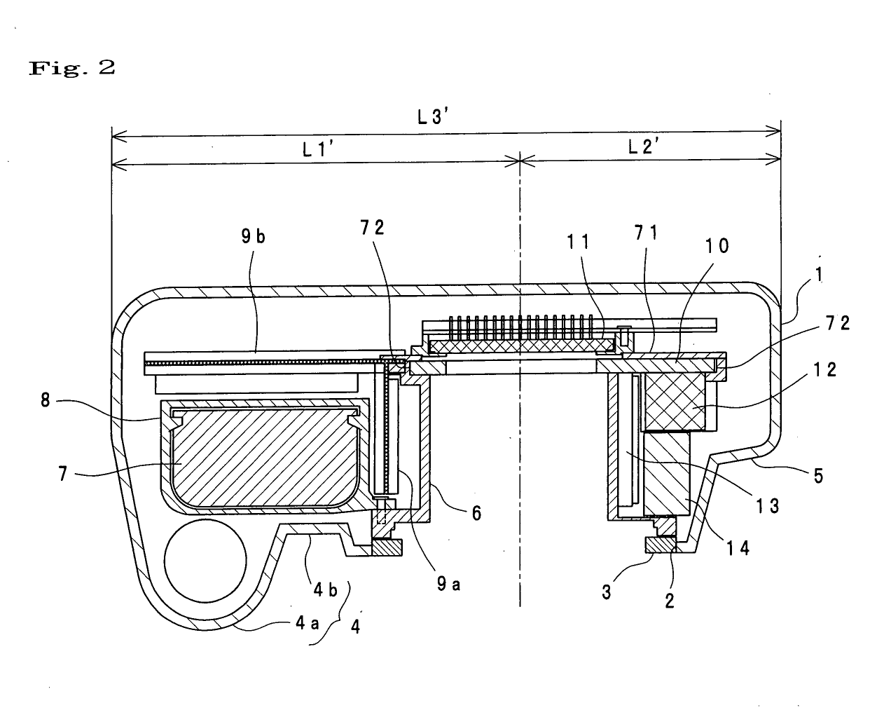

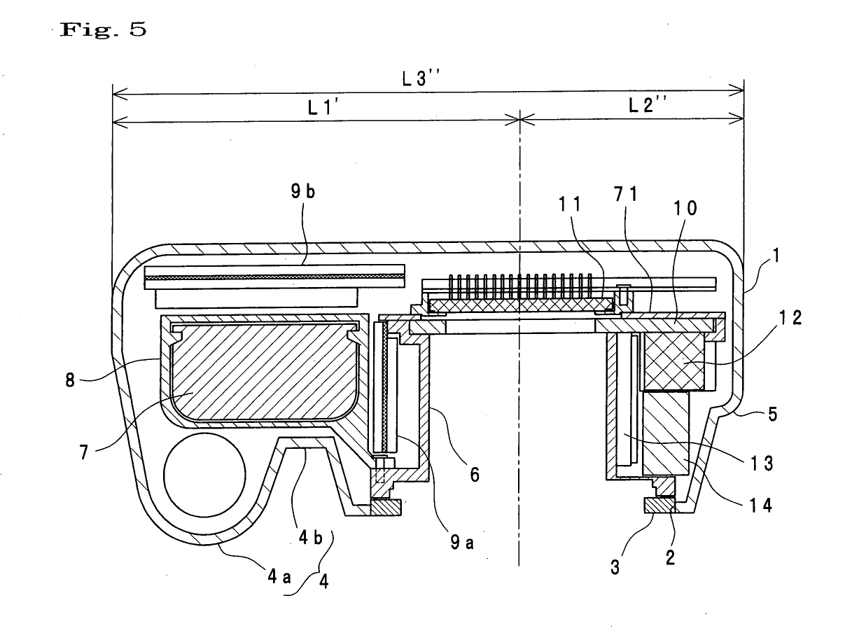

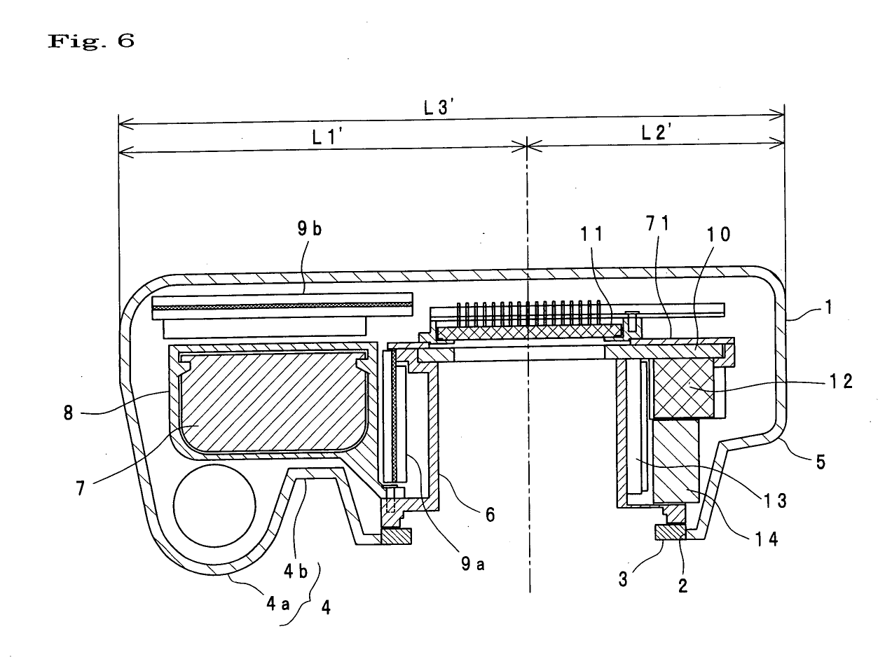

FIGS. 5 and 6 show variations of the camera of the above embodiment. In the camera of above arrangement construction, the hold portion 5 is provided on the right side of the body 1 in order to ensure the holdness of the left hand, though, when pursuing further compactness, it is possible to further minify the dimension L2″ of the right side by minimizing or eliminating the hold portion 5 as shown in FIG. 5. In the camera of above arrangement construction, the dimension L1′ of the left side of the imaging optical path is decided substantially by the battery storage portion 8, though, even if the second circuit board 9b having a wider width than the battery storage portion 8 exists, it is possible to ensure the same lateral width L3′ as that of FIG. 2 by disposing the second circuit board 9b in the rear ward of the imaging device 11.

The aforementioned embodiment is so called a digital camera using the imaging device 11, though the present invention can also be applied to a silver salt camera. The digital camera involves many electric or electronic devices and uses the battery 7 having a large capacity, i.e. a large volume and the circuit boards 9a, 9b, 9c each having a large size. Therefore, the present invention is particularly applicable to such a digital camera.

Next, the drive unit 14, the mirror drive portion 13 and the shutter drive portion 12 of the camera of above embodiment will be explained in detail.

<Drive Unit>

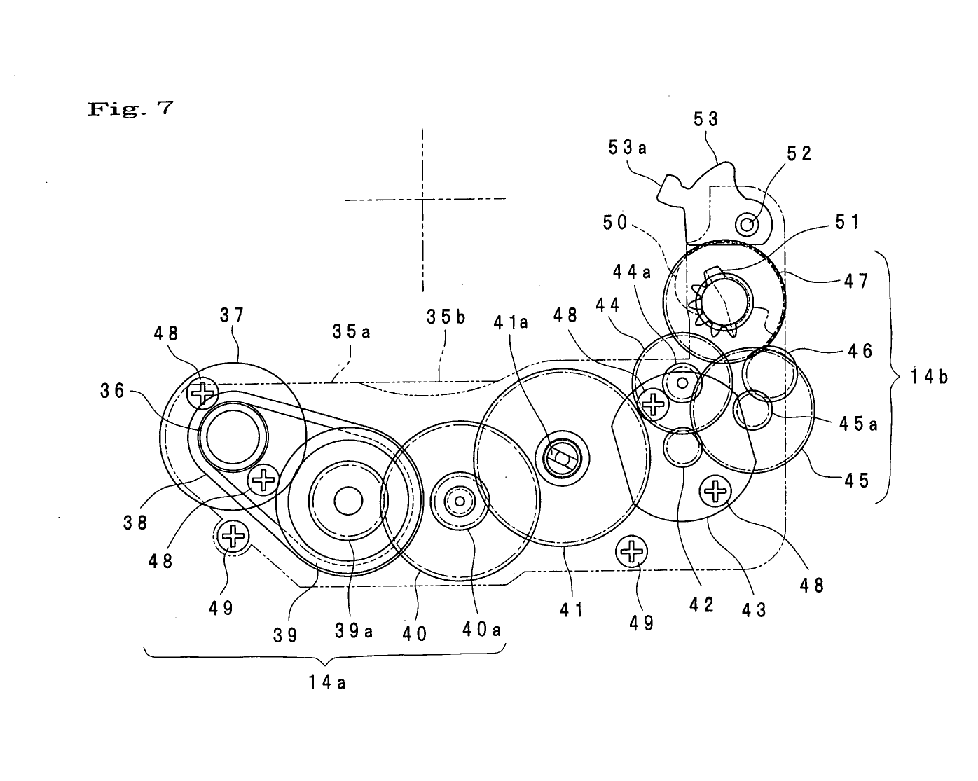

FIG. 7 shows the drive unit 14. The drive unit 14 comprises a focus drive portion 14a for driving a focus lens group of the interchangeable lens not shown and a charge portion 14b for charging the mirror drive portion 13 to drive the main mirror 28 and the sub-mirror 29 from the second position on the outside of the imaging optical path to the first position on the inside of the imaging optical path and charging the shutter drive portion 12. These portions are assembled so as to be sandwiched in a direction of optical axis by two drive base plates 35a, 35b of inverse L shape.

The focus drive portion 14a comprises a focus motor 37 with a drive pulley 36 fixed on a drive shaft, a driven pulley 39 coupled to the drive pulley 36 of the focus motor 37 via belt 38, a first gear 40 engaged with a transmission gear 39a of the driven pulley 39, and a second gear 41 engaged with a transmission gear 40a of the first gear 40 so that rotation of the second gear 41 allows a coupler 41a of key shape to rotate and engage with a coupler of the interchangeable lens not shown to drive a focus lens.

The charge portion 14b comprises a charge motor 43 with a drive gear 42 fixed on a drive shaft, a third gear 44 engaged with a drive gear 42 of the charge motor 43, a fourth gear 45 engaged with a transmission gear 44a of the third gear 44, a fifth gear 46 engaged with a transmission gear 45a of the fourth gear 45, and a sixth gear 47 engaged with the fifth gear 46 so that the sixth gear 47 is driven in a counterclockwise direction in FIG. 7. The focus motor 37 and the charge motor 43 are fixed on the rear surface of the drive base plate 35b positioned on the rear side by means of screws 48 while other parts are supported between two drive base plates 35a, 35b. Two drive base plates 35a, 35b are integrally combined by means of screws 49.

The sixth gear of the charge portion 14b is integrally formed with a mirror charge cam portion 56 which charges a mirror charge spring 56 for operating the mirror which will be explained hereinafter, and a shutter charge gear portion 51 which charges a shutter charge spring 65 for driving the shutter blades 25a, 25b, 25c, 25d, which will be explained hereinafter.

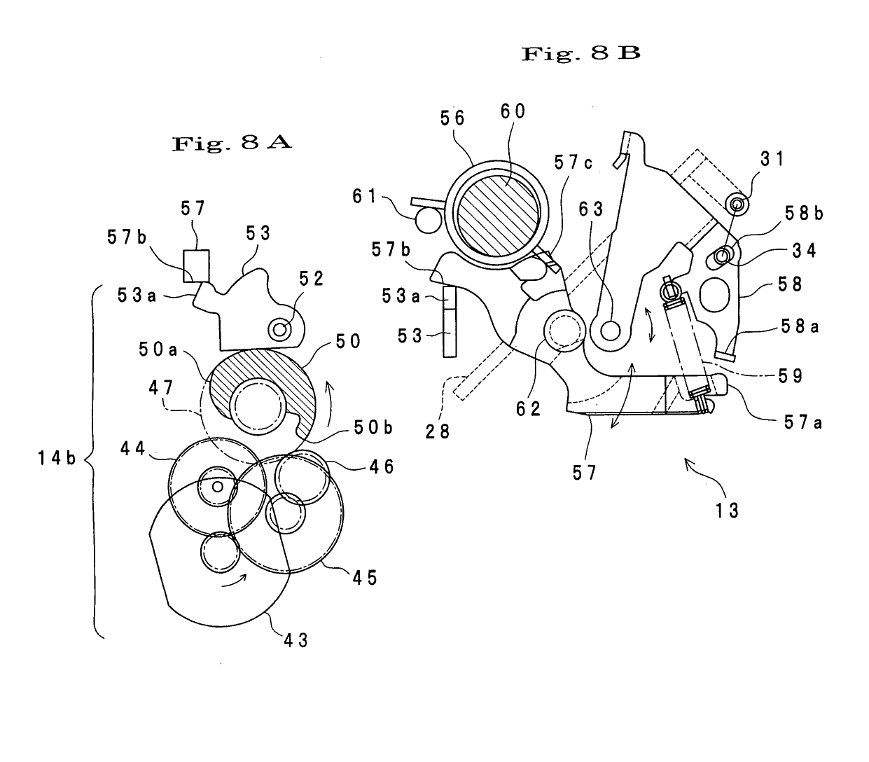

As shown in FIGS. 8A, 8B, a mirror charge lever 53 which is biased in a counterclockwise direction around a support shaft 52 abuts against the mirror charge cam portion 50 of the sixth gear 47 so that a cam surface 50a rotates the mirror charge lever 53 in a clockwise direction and rotates the mirror charge lever 53 in a counterclockwise direction when a cam end 50b passes through the mirror charge lever 53. On the mirror charge lever 53 is formed a projection 53a which abuts against an abutment 57b of a first mirror drive lever 57 of the mirror drive portion 13 which will be explained hereinafter.

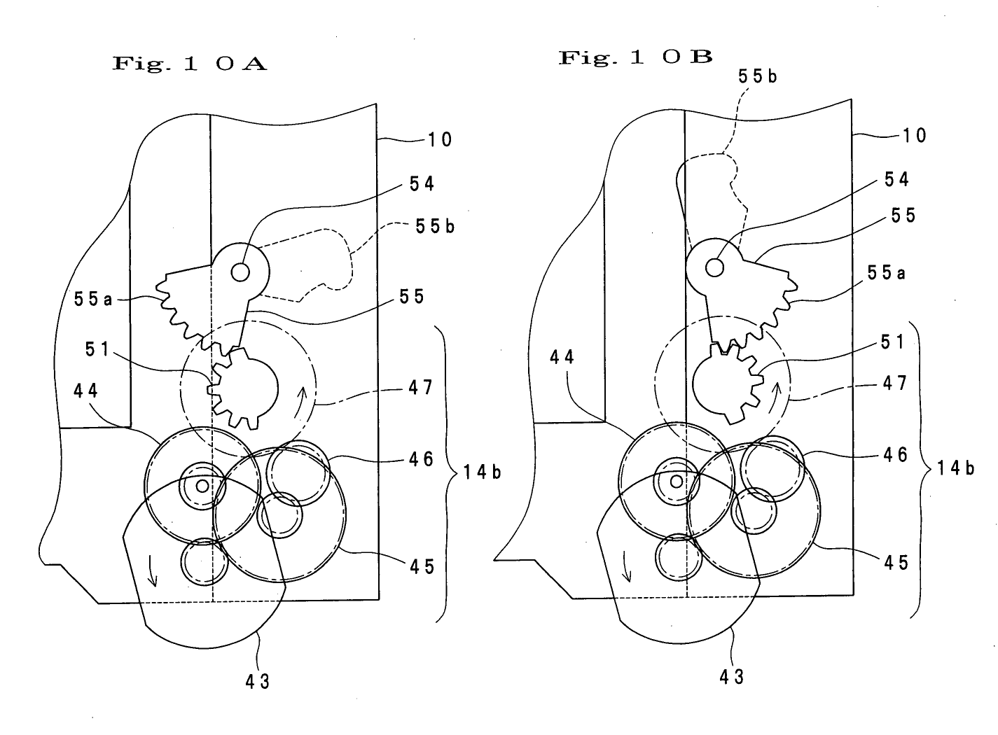

As shown in FIG. 10, the shutter charge gear portion 51 of the sixth gear 47 engages with a gear portion 55a formed on one end of a shutter charge lever 55 which is biased in a counterclockwise direction around a support shaft 54 by means of biasing means not shown so that the shutter charge lever 55 is rotated in a clockwise direction and rotated in a counterclockwise direction when an engagement of the shutter charge lever 55 with the gear portion 55a is released. On the shutter charge lever 55 is formed an abutment 55b which abuts against a cam portion 64c of the shutter drive lever 64 of the shutter drive portion 12 which will be explained hereinafter. The shutter charge gear portion 51 and the shutter charge lever 55 constitute a second drive means of the shutter.

<Mirror Drive Portion>

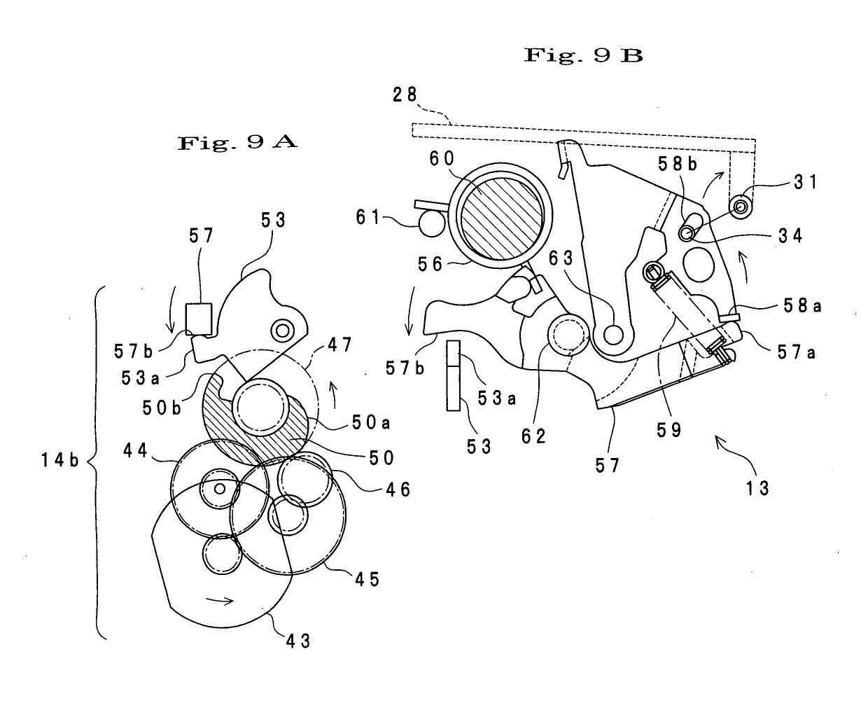

The mirror drive portion 13, as shown in FIGS. 8B, 9B, comprises a first mirror charge spring 56, a first mirror drive lever 57, a second mirror drive lever 58, and a second mirror charge spring 59. The first mirror charge spring 56 is held on a projection 60 of the frame body 6. One end of the spring 56 is restrained by a boss 61 of the frame body 6 while the other end of the spring 56 is restrained by the first mirror drive lever 57. The first mirror drive lever 57 is provided on the frame body 6 so as to rotate around a support shaft 62. One end of the lever 57 is formed with an abutment 57a for abutting against a projection piece 58a of the second mirror drive lever 58 while the other end of the lever 57 is formed with an abutment 57b against which the projection 53a of the mirror charge lever 53 abuts and a restraining portion 57c for restraining the other end of the second mirror charge spring 56. The second mirror drive lever 58 is provided on the frame 6 so as to rotate around a support shaft 63. One end of the lever 58 is formed with a projection piece 58a against which the abutment 57a of the first mirror drive lever 57 abuts and a cam hole 58b into which the drive shaft 34 of the main mirror holder 30 enters. The second mirror charge spring 59 is connected between the first mirror drive lever 57 and the second mirror drive lever 58.

<Charge/Run Operation of Mirror>

Driving of the charge motor 43 of the charge portion 14b of the drive unit 14 allows the sixth gear 47 to rotate in a counterclockwise direction, causing the cam surface 50a of the mirror charge cam portion 50 formed on the sixth gear 47 to rotate the mirror charge lever 53 in a clockwise direction. The projection 53a of the mirror charge lever 53 rotates the first mirror drive lever 57 of the mirror drive portion 13 in a clockwise direction. Thus, the first mirror charge spring 56 is charged. Rotation of the first drive lever 57 is transmitted to the second mirror drive lever 58 via the second mirror charge spring 59, causing the second mirror drive lever 58 to rotate in a clockwise direction. As a result, the cam hole 58b of the second mirror drive lever 58 rotates the main mirror holder 30 in a counterclockwise direction via the drive shaft 34, resulting in a charge complete state of FIG. 8.

When the sixth gear 47 further rotates in a counterclockwise direction so that the mirror charge lever 53 is released from the cam end 50b of the mirror charge cam portion 50, spring force charged in the first mirror charge spring 56 allows the first mirror drive lever 57 to rotate in a clockwise direction. Then, the abutment 57a of the first mirror drive lever 57 abuts against the projection piece 58a of the second mirror drive lever 58, causing the second mirror drive lever 58 to rotate in a counterclockwise direction. As a result, the cam hole 58b of the second mirror drive lever 58 runs the main mirror holder 30 in a clockwise direction via the drive shaft 34, resulting in a run complete state of FIG. 9.

<Shutter Drive Portion>

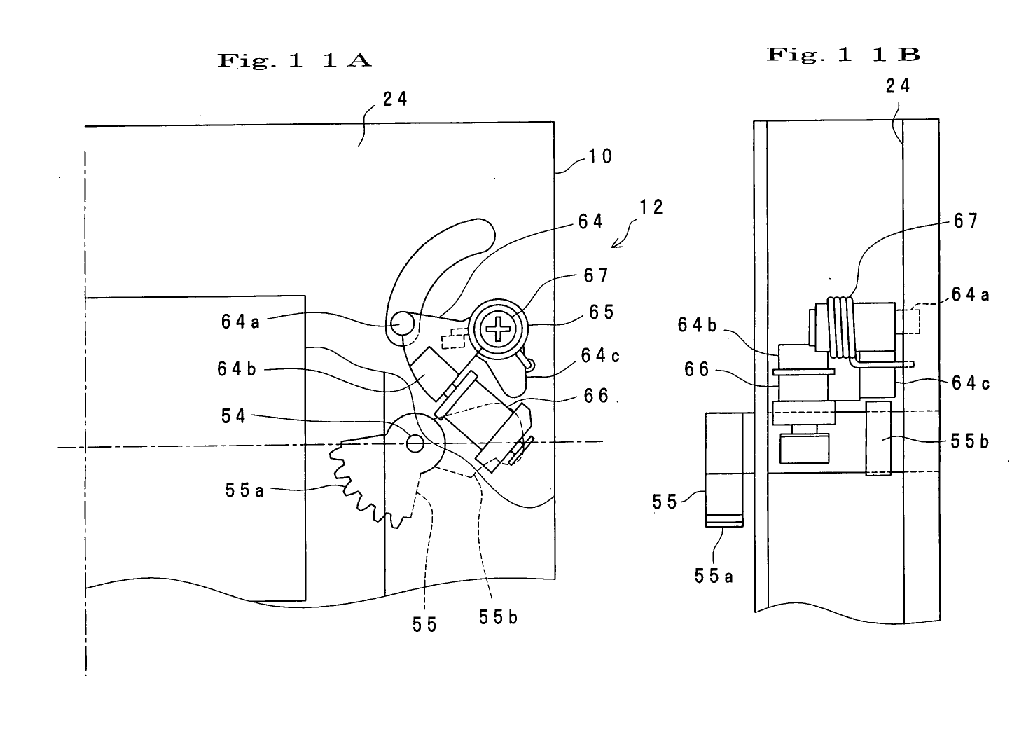

The shutter drive portion 12, as shown in FIG. 11, comprises a shutter drive lever 64, a shutter charge spring 65, and an electromagnet 66 and constitutes a first drive means. The shutter drive lever 64 is attached on a shutter base 24 so as to rotate around a support shaft 67 and is provided with a cam pin 64a which fits into the cam hole 27 of the shutter blade 25a of FIG. 4 and an absorption piece 64b. The shutter drive lever 64 is integrally formed with a cam portion 64c. The shutter charge spring 65 is held on the support shaft 67 of the shutter drive lever 64. One end of the spring 65 is restrained by the shutter base 24 while the other end of the spring 65 is restrained by the shutter drive lever 64. The electromagnet 66 is attached on the shutter base 24 so that the absorption surface of the electromagnet 66 can absorb the absorption piece 64b held on the shutter drive lever 64.

<Charge/Run Operation of Shutter>

In FIG. 10, driving of the charge motor 43 of the charge portion 14b of the drive unit 14 allows the sixth gear 47 to rotate in a counterclockwise direction, causing the shutter charge portion 51 formed on the sixth gear 47 to rotate the shutter charge lever 55 in a clockwise direction. The abutment portion 55b of the shutter charge lever 55, as shown in FIG. 11, abuts against the cam portion 64c of the shutter drive lever 64 to rotate the shutter drive lever 64 in a counterclockwise direction. Thus, the shutter charge spring 65 is charged. The cam pin 64a of the shutter drive lever 64 pushes the cam hole 27 of the shutter blade 25a. As a result, all of the shutter blades 25a-25d are moved via the link members 26a-26c to close the exposure window 23 of the shutter base 24, resulting in a charge complete state of FIG. 4A. At this time, the electromagnet 66 is energized to absorb the absorption piece 64b held in the shutter drive lever 64, holding the charge complete state.

When the sixth gear 47 further rotates in a counterclockwise direction, the engagement of the shutter charge gear portion 51 with the gear 55a of the shutter charge lever 55 is released. At this time, when the electromagnet 66 is disenergized, a spring force charged in the shutter charge spring 65 allows the shutter drive lever 64 to rotate in a clockwise direction. As a result, the cam pin 64a of the shutter drive lever 64 pushes the cam hole 27 of the shutter blade 25a to run the shutter blades 25a-25d, resulting in a run complete state of FIG. 4B. In this embodiment, as the shutter blades 25a-25d run only in an open direction, termination of exposure is conducted by terminating electric charge storage into the imaging device 11.

Thus, the shutter blades 25a-25d utilize, as a drive source, a returning force of the shutter charge spring 65 charged by two levers of the shutter charge lever 55 and the shutter drive lever 64, making the construction very simple. The drive source for charging the shutter charge spring 65 utilizes the drive source for charging the mirror charge spring 56, 59, making an exclusive drive source unnecessary and resulting in a simple and cheap drive means. Then again, the shutter drive portion 12 has a large dimension in a direction of image optical path in comparison with the shutter body 10, causing a problem of arrangement thereof. However, this problem is solved by disposing the shutter drive portion 12 on the right side of the imaging optical path as in the above embodiment.

<Mounting/Dismounting Construction of Shutter Unit and Drive Unit>

Next, a construction for mounting and dismounting the shutter body 10, the shutter drive portion 12 and the drive unit 14 of the camera in the aforementioned embodiment will be explained. Hereinafter, a unit comprising the shutter body 10 and the shutter drive portion attached on the shutter body 10 is referred to as shutter units 10, 12.

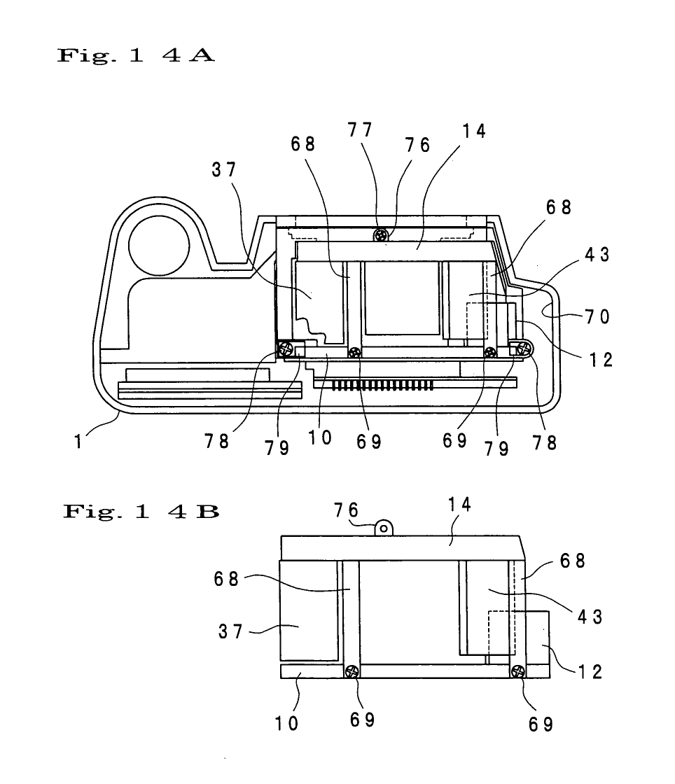

The shutter units 10, 12 and the drive unit 14 are connected, as shown in FIG. 14, by a holding frame (holding means) 68 and integrally fixed as a shutter block by means of fixing screws 69. The elements constituting the shutter block comprise, in this embodiment, the shutter units 10, 12 and the drive unit 14 but may comprise the shutter units 10, 12 and at least any one of the focus drive portion 14a, the charge portion 14b, the focus motor 37, and the charge motor 43 of the drive unit 14.

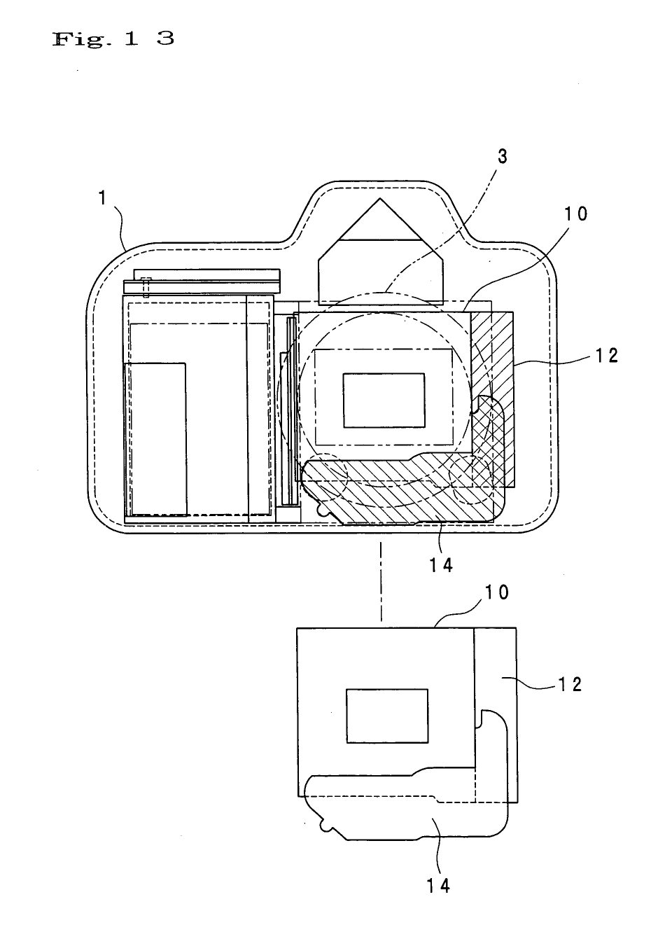

The shutter units 10, 12 and the drive unit 14, as shown in FIG. 13, can be inserted into the inside of the body 1 from an opening 70 on the bottom of the body 1 in a vertical direction that is a first axial direction within a surface perpendicular to the optical axis, and can be removed from the body 1. The front surface of the shutter body 10 of the shutter units 10, 12, as shown in FIG. 2, is guided by the rear end surface of the frame body 6 while the rear surface is guided by a shutter holding plate 71. The rear end surface of the frame 6 and the shutter holding plate 71 constitute a first shutter restraining portion for restraining movement of the shutter body 10 in a direction of optical axis. The left and right ends of the shutter body 10 are guided by a restraining portion 72 formed on the frame body 6. The restraining portion 72 constitutes a second shutter restraining portion for restraining movement of the shutter body 10 in a second axial direction perpendicular to the first axial direction within a surface perpendicular to the optical axis. The upper end of the shutter body 10, as shown in FIGS. 3A, 3B, is restrained by a restraining portion 73 formed on the frame body 6. The restraining portion 73 constitutes a third shutter restraining portion for restraining the insertion position of the shutter body 10 in the first axial direction.

The drive unit 14, as shown in FIGS. 3A, 3B, is fixed in its position by inserting a boss 74 formed on the upper end of drive base plate 35b into a hole 75 formed on the bottom wall of the frame body 6. The shutter units 10, 12 and the drive unit 14, as shown in FIG. 14, are fixed by fixing a projection piece 76 provided on the drive base plate 35a of the drive unit 14 using a press screw 77 and then fixing the both ends of the shutter body 10 using press metal pieces 79 each of which is pivotably and fixably provided on the frame body 7 by means of screw 8. Attaching the press screw 77 and the press metal pieces 79 can prevent the shutter units 10, 12 and the drive unit 14 from dropping downward from the body 1. In addition, removing the press screw 77 and the press metal pieces 79 allows the shutter units 10, 12 and the drive unit 14 to be removed from the body 1. After completion of exchanging work, an bottom outer casing member not shown is attached on the bottom of the camera, resulting in completion of work.

The shutter units 10, 12 and the drive unit 14 are essential parts that conduct dynamical work every time of photographing. Therefore, endurance of these parts affects mechanical lifetime of the camera. In the aforementioned embodiment, since the shutter units 10, 12 and the drive unit 14 are integrally constituted as a shutter block, the exchanging workability from the bottom of the body 1 as shown in FIG. 13 is effective.

In addition, the accuracy of the distance in an optical axis and the relative inclination between the mount 3, which is a boundary between the interchangeable lens and the body, and the imaging device 11 affects focusing performance of the camera. In the aforementioned embodiment, since it is not necessary to remove the mount 3 or the imaging device 11 when exchanging or inspecting the shutter units 10, 12 and the drive unit 14, the distance and the relative inclination between the mount 3 and the imaging device 11 are never varied. Thus, the focal adjustment and so on after exchanging or inspecting the shutter units 10, 12 and the drive unit 14 is not necessary.

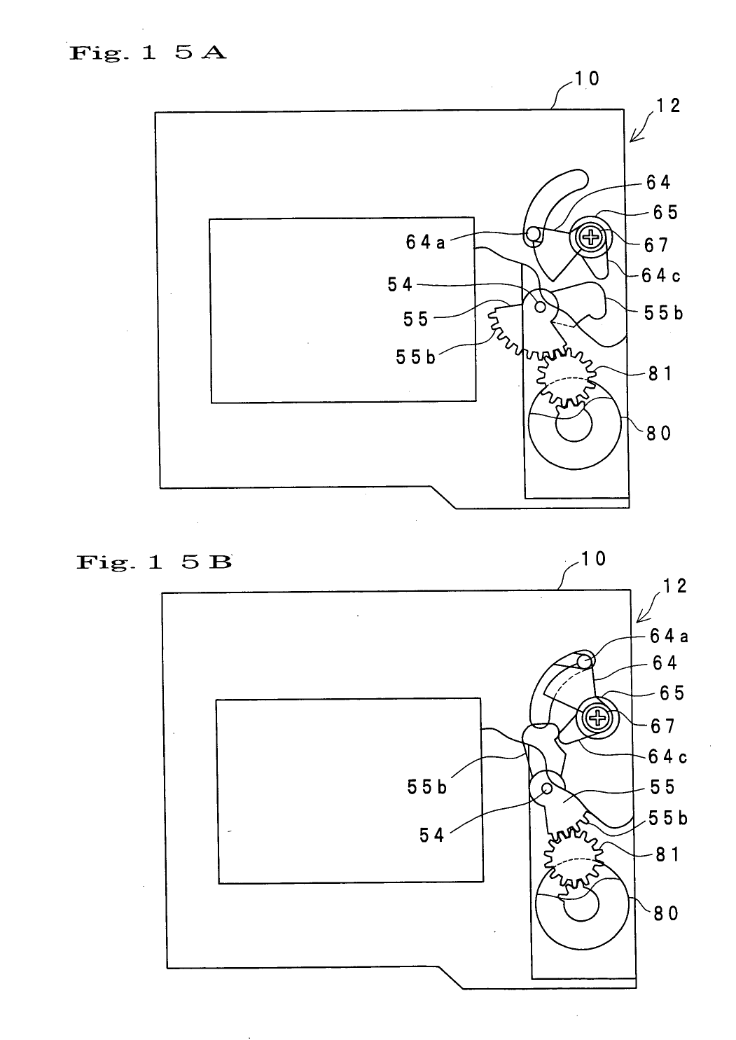

In the aforementioned embodiments, the drive source for charging the shutter charge spring 65 of the shutter drive portion 12 is cooperate with the drive force for charging the mirror charge springs 56, 59 of the mirror drive portion 13. However, as shown in FIG. 15, an independent shutter charge motor 80 for charging the shutter charge spring 65 of the shutter drive portion 12 and an intermediate gear 81 may be provided in the shutter drive portion 12. In this case, it is also possible to dispose the shutter drive portion 12 on the right side of the imaging optical path, making the body compact. In addition, the drive unit 14 does not need the shutter charge portion 51, eliminating restriction of arrangement and allowing high degree of freedom of arrangement.

In the aforementioned embodiments, the shutter is a type that the shutter blades 25a-25d run upward to open the exposure window 23, though the run direction of the shutter blades is not limited to this. Even in a shutter comprising fore blades and rear blades, it is also possible to dispose the shutter drive portion on the right side of the imaging optical path, making the body compact.

The aforementioned embodiments are an interchangeable lens type of camera, though the present invention may be applied to a non-interchangeable lens type of camera in the same manner.

Although the present invention has been fully described by way of the examples with reference to the accompanying drawings, it is to be noted here that various changes and modifications will be apparent to those skilled in the art. Therefore, unless such changes and modifications otherwise depart from the spirit and scope of the present invention, they should be construed as being included therein.

1. An imaging apparatus, comprising:
an imaging unit on which a subject image entered in an imaging optical path is focused;
a grip portion to be held when imaging operation;
a driven unit which is disposed substantially in the vicinity of the imaging unit and conducts a part of imaging operation of the imaging apparatus; and
a driving unit which drives the driven unit, a part of the driving unit being disposed on the opposite side to the grip portion with respect to the imaging optical path.

2. The imaging apparatus as in claim 1, wherein the driven unit is a shutter member, and wherein the part of imaging operation is to allow and disallow an imaging light flux to pass toward the imaging unit.

3. The imaging apparatus as in claim 2, wherein the part of the driving unit is further disposed substantially in the vicinity of the imaging unit.

4. The imaging apparatus as in claim 1, further comprising:
an electric circuit board for controlling the imaging unit; and
a battery storage portion for storing a battery for driving the imaging apparatus;
wherein at least one of the electric circuit board and the battery storage portion is disposed substantially in the vicinity of the imaging unit and on the side of the grip portion.

5. The imaging apparatus as in claim 1, wherein the part of the driving unit is at least one of a first drive unit for moving the shutter member from a first position to a second position and a second drive unit for moving the shutter member from the second position to the first position.

6. The imaging apparatus as in claim 5, wherein the first drive unit utilizes a resilient force of a spring as a drive source.

7. The imaging apparatus as in claim 5, wherein the second drive unit is provided with an at least one actuator of electromechanical conversion family.

8. An imaging apparatus, comprising:
an imaging unit on which a subject image entered in an imaging optical path is focused;
a grip portion to be held when imaging operation, the grip portion being disposed on one end of the imaging apparatus;
a driven unit which is disposed substantially in the vicinity of the imaging unit and conducts a part of imaging operation of the imaging apparatus; and
a driving unit which drives the driven unit; characterizing in that:
the grip portion, the imaging unit and the driving unit are disposed in this order from the one end of the imaging apparatus where the grip portion is disposed to the other opposite end.

9. The imaging apparatus as in claim 8, wherein the driven unit is a shutter member, and wherein the part of imaging operation is to allow and disallow an imaging light flux to pass toward the imaging unit.

10. The imaging apparatus as in claim 9, wherein a part of the driving unit is disposed substantially in the vicinity of the imaging unit.

11. An imaging apparatus, comprising:
an imaging unit on which a subject image entered in an imaging optical path is focused;
a shutter body which is disposed substantially in the vicinity of an imaging surface of the imaging unit, the shutter body comprising a shutter blade which is movable within a surface perpendicular to the imaging optical path between a first position where an imaging light flux is interrupted and a second position where the imaging light flux is allowed to pass;
a shutter drive unit for driving the shutter blade; and
a grip portion to be held when imaging operation;
wherein at least a part of the shutter drive unit is disposed substantially in the vicinity of the imaging surface and on the opposite side to the grip portion with respect to the imaging optical path.

12. The imaging apparatus as in claim 11, the imaging unit is an imaging device of photo-electrical conversion family.

13. The imaging apparatus as in claim 11, further comprising:
an electric circuit board for controlling the imaging unit; and
a battery storage portion for storing a battery for driving the imaging apparatus;
wherein at least one of the electric circuit board and the battery storage portion is disposed substantially in the vicinity of the imaging unit and on the side of the grip portion.

14. The imaging apparatus as in claim 11, wherein the part of the driving unit is at least one of a first drive unit for moving the shutter member from a first position to a second position and a second drive unit for moving the shutter member from the second position to the first position.

15. The imaging apparatus as in claim 14, wherein the first drive unit utilizes a resilient force of a spring as a drive source.

16. The imaging apparatus as in claim 14, wherein the second drive unit is provided with an at least one actuator of electro-mechanical conversion family.
